(19) United States
(12) Patent Application Publication
(10) Pub. No.: US 2013/0271828 A1
(43) Pub. Date: Oct. 17, 2013

(54) ARTICLES HAVING OPTICAL ADHESIVES AND METHOD OF MAKING SAME

(71) Applicants: Albert I. Everaerts, Oakdale, MN (US); Sunil K. Pillalamarri, Rosemount, MN (US); Michael J. Ruether, Woodbury, MN (US)

(72) Inventors: Albert I. Everaerts, Oakdale, MN (US); Sunil K. Pillalamarri, Rosemount, MN (US); Michael J. Ruether, Woodbury, MN (US)

(73) Assignee: 3M INNOVATIVE PROPERTIES COMPANY, St. Paul, MN (US)

(21) Appl. No.: 13/995,693

(22) PCT Filed: Dec. 16, 2011
(86) PCT No.: PCT/US2011/065434

§ 371 Date: Jun. 19, 2013

Related U.S. Application Data
(60) Provisional application No. 61/425,487, filed on Dec. 21, 2010.

(51) Int. Cl. G02B 5/20

(52) U.S. Cl. CPC G02B 5/20; G02B 5/208
USPC 359/361; 359/885; 156/60; 156/275.7

(57) ABSTRACT

The present invention is an optical bonding layer including an optical film and a liquid optically clear adhesive positioned adjacent the optical film. The optical film is one of an optically clear film adhesive, a stretch releasable optically clear contrast enhancement film and a stretch releasable carrier film. The optical bonding layer has a transmittance of at least about 75%.

### CROSS REFERENCE TO RELATED APPLICATION

This application claims the benefit of U.S. Provisional Patent Application No. 61/425,487, filed Dec. 21, 2010, the disclosure of which is incorporated by reference herein in its entirety.

### TECHNICAL FIELD

The present invention relates generally to an optical assembly suitable for use in a display device. In particular, the present invention is an optical assembly including optical substrates bonded together using an optical bonding layer.

### BACKGROUND

Optical bonding may be used to adhere together two optical elements using an optical grade bonding composition. In display applications, optical bonding may be used to adhere together optical elements such as display panels, glass plates, touch panels, diffusers, rigid compensators, and flexible films such as polarizers and retarders.

In the area of displays, optically clear adhesives (OCAs) are commonly used to attach a cover sheet (i.e., glass, polycarbonate, PMMA) to an underlying liquid crystal display (LCD) module. In some cases, two layers of OCA are used to attach the display substrates. One layer is used to attach a cover lens to a touch panel and a second layer is used to attach the touch panel to the LCD. The OCAs provide mechanical attachment between the display substrates, improve shock resistance and are tailored to better match the refractive index of the substrates. As a result, the bonded display assembly has improved transmittance (i.e., reduced reflectance) and enhanced display contrast.

When both display substrates are flat (i.e., do not contain any significant topography or curvature), an adhesive tape such as a contrast enhancement film (CEF) is commonly used and is applied using simple roller lamination. However, when both substrates are flat but also rigid, it is difficult to laminate the adhesive without using an autoclave step to remove the air bubbles trapped during lamination. The bubbles, or air gaps, between optical elements in the display can hinder the optical performance of the display. The performance of the display can be improved by removing or minimizing the number of air gaps, and consequently minimizing the number of internal reflecting surfaces of the display.

In some applications, one or both of the display substrates are curved or contain 3-dimensional topography, such as an ink step. Due to height differences at the intersection of the ink step and clear viewing area, it may be difficult to laminate these substrates with OCA alone without trapping any air bubbles. One solution to this problem is to apply the adhesive in liquid form. Liquid optically clear adhesives (LOCAs) offer improved wetting of both flat and 3-dimensional (i.e., curved, warped, with ink step features, etc.) substrates and eliminate the need for vacuum lamination and autoclave processes. However, special processing is needed to dispense LOCAs and bond the substrates together. In addition, one potential concern with using LOCAs alone can be high stress formation during curing of the adhesive. This curing induced stress can result in Mura, delamination, bubble formation or other types of failure. With thick layers of LOCAs, curing can also result in a significant exotherm, which can damage the display.

### SUMMARY

In one embodiment, the present invention is an optical bonding layer including an optical film and a first liquid optically clear adhesive (LOCA) positioned adjacent the optical film. The optical bonding layer has a visible light transmittance of at least about 75%.

In another embodiment, the present invention is a display assembly including a first substrate, a second substrate and an optical bonding layer positioned between the first substrate and the second substrate. The optical bonding layer includes an optical film and a first liquid optically clear adhesive (LOCA) positioned adjacent the optical film.

In yet another embodiment, the present invention is a method of making a display assembly. The method includes positioning an optical film onto a first substrate; laminating the first substrate with the optical film; dispensing a liquid optically clear adhesive (LOCA) onto a second substrate; contacting the optical film and the LOCA, wherein the optical film and the LOCA form an optically clear bonding layer; laminating the second substrate to the LOCA; and curing the optical bonding layer.

### BRIEF DESCRIPTION OF DRAWINGS

FIG. 1a is a top view of a substrate of an optical assembly of the present invention.

FIG. 1b is a perspective view of the substrate of FIG. 1A.

FIG. 2a is a cross-sectional view of a first embodiment of an optical film of the present invention.

FIG. 2b is a cross-sectional view of a second embodiment of an optical film of the present invention.

FIG. 2c is a cross-sectional view of a third embodiment of an optical film of the present invention.

FIG. 2d is a cross-sectional view of a fourth embodiment of an optical film of the present invention.

FIG. 3 is a cross-sectional view of an assembly including a first embodiment of an optical bonding layer of the present invention.

FIG. 4 is a process diagram for bonding a first substrate and a second substrate together using the optical bonding layer illustrated in FIG. 3.

FIG. 5 is a cross-sectional view of an assembly including a second embodiment of an optical bonding layer of the present invention.

FIG. 6 is a process diagram for bonding a first substrate and a second substrate together using the optical bonding layer illustrated in FIG. 5.

FIG. 7 is a cross-sectional view of an assembly including a third embodiment of an optical bonding layer of the present invention.

FIG. 8 is a process diagram for bonding a first substrate and a second substrate together using the optical bonding layer illustrated in FIG. 7.

FIG. 9 is a cross-sectional view of an assembly including a fourth embodiment of an optical bonding layer of the present invention.

FIG. 10 is a process diagram for bonding a first substrate and a second substrate together using the optical bonding layer illustrated in FIG. 9.

FIG. 11 is a cross-sectional view of an assembly including a fifth embodiment of an optical bonding layer of the present invention.

FIG. 12 is a process diagram for bonding a first substrate and a second substrate together using the optical bonding layer illustrated in FIG. 11.

### DETAILED DESCRIPTION

The invention disclosed herein describes optical assemblies having an optical bonding layer and optical bonding methods. The optical assemblies include two optical substrates bonded together with an optical bonding layer. Optical bonding improves display performance by eliminating air gaps in a display, resulting in improved sunlight readability, contrast and luminance, ruggedness and resistance to high shock and vibration, and can eliminate condensation and moisture collection between two substrates. The optical bonding layer of the present invention includes a liquid optically clear adhesive (LOCA) and an optical film. The optical film may be an adhesive or a plastic film, such as an optically clear film, a diffuser film, a stretchable optical clear or diffusive film, and the like. The LOCA may be a radiation curable adhesive with optical quality, such as an optically clear or diffusive adhesive. The combination of a LOCA and an optical film results in improved wetting of the optical substrates and reduced assembly stress, allows for bonding of parallel and non-parallel substrates, and facilitates re-workability and removability in certain constructions.

Exemplary assemblies of the present invention are defined by optical bonding layers that provide optical bonding between the first and second optical substrates and that do not delaminate under normal use or under application of specific industry standard accelerated aging tests. For example, assemblies of the present invention do not delaminate under elevated temperature storage conditions of about 65 degrees or about 85 degrees Celsius for a duration of between about 300 and about 1000 hours. The assemblies of the present invention also do not delaminate under conditions of heat and humidity storage, for example, at about 65 degrees Celsius and about 95% relative humidity for a duration of between about 300 and about 1000 hours.

The optical bonding layer allows the assembly to be reworked with little or no damage to the components. In one embodiment, the optical bonding layer has a cleavage strength of about 15 N/mm or less, about 10 N/mm or less and about 6 N/mm or less between glass substrates, such that reworkability can be obtained with little or no damage to the components. In one embodiment, the total energy to cleavage is less than about 25 kg over a 2.5 cm by 2.5 cm area. The bonding layer may be reworked by stretch removal of a stretchable carrier film.

The optical bonding layer may have any suitable thickness. The particular thickness employed in the optical assembly may be determined by a number of factors. For example, the design of an optical device in which the optical assembly is used may require a certain gap between the optical substrates. In one embodiment, the optical bonding layer has a thickness of from about 1 μm to about 12 mm, from about 1 μm to about 5 mm, from about 50 μm to about 2 mm, from about 50 μm to about 1 mm, from about 50 μm to about 0.5 mm or from about 50 μm to about 0.2 mm.

An adhesive of the present invention is considered to be optically clear if it exhibits an optical transmission of at least about 75% and a haze value of below about 10%, as measured on a 25 μm thick sample in the manner described below. The optical bonding layer has optical properties suitable for the intended application. For example, the optical bonding layer may have at least about 85% transmission over the range of from about 400 to about 720 nm. The optical bonding layer may have, per millimeter thickness, a transmission of greater than about 85% at 460 nm, greater than about 90% at 530 nm and greater than about 90% at 670 nm. In one embodiment, the optical bonding layer has a transmission percentage of at least about 80%, particularly about 85% and more particularly about 88% after 30 days at room temperature and controlled humidity conditions (CTH). In another embodiment, the optical bonding layer has a transmission percentage of at least about 75%, particularly about 77.5% and more particularly about 80% after 30 days of heat aging at 65° C. and 90% relative humidity. In yet another embodiment, the optical bonding layer has a transmission percentage of at least about 75%, particularly about 77.5% and more particularly about 80% after 30 days of heat aging at 70° C. These transmission characteristics provide for uniform transmission of light across the visible region of the electromagnetic spectrum which is important to maintain the color point if the optical assembly is used in full color displays. The optical bonding layer particularly has a refractive index that matches or closely matches that of the first and/or second optical substrates. In one embodiment, the optical bonding layer has a refractive index of from about 1.4 to about 1.6.

In yet another embodiment, the optical film and/or the LOCA may have light diffusive properties, color compensation properties, UV absorption (cut-off of light transmission below ˜400 nm) and IR absorption (cut-off of light transmission above ˜800 nm), etc.

The optical assemblies of the present invention include an optical bonding layer positioned between a first substrate and a second substrate. Any suitable, transparent optical substrate can be bonded using the present method. In one embodiment, the optical substrates include a display panel and a substantially light transmissive substrate.

The optical substrates may be formed of glass, polymers, composites and the like. The type of material used for the optical substrates generally depends on the application in which the assembly will be used.

Suitable optical substrates can be of any Young's modulus and may be, for example, rigid (e.g., the optical substrate may be a 6 millimeter-thick sheet of plate glass) or flexible (e.g., the optical substrate may be a 37 micrometer-thick polyester film).

As with the type of material, the dimensions and surface topography of the optical substrates generally depend on the application in which the optical assembly will be used. The surface topography of an optical substrate may also be roughened. Optical substrates having rough surface topographies can be effectively laminated in accordance with the present invention.

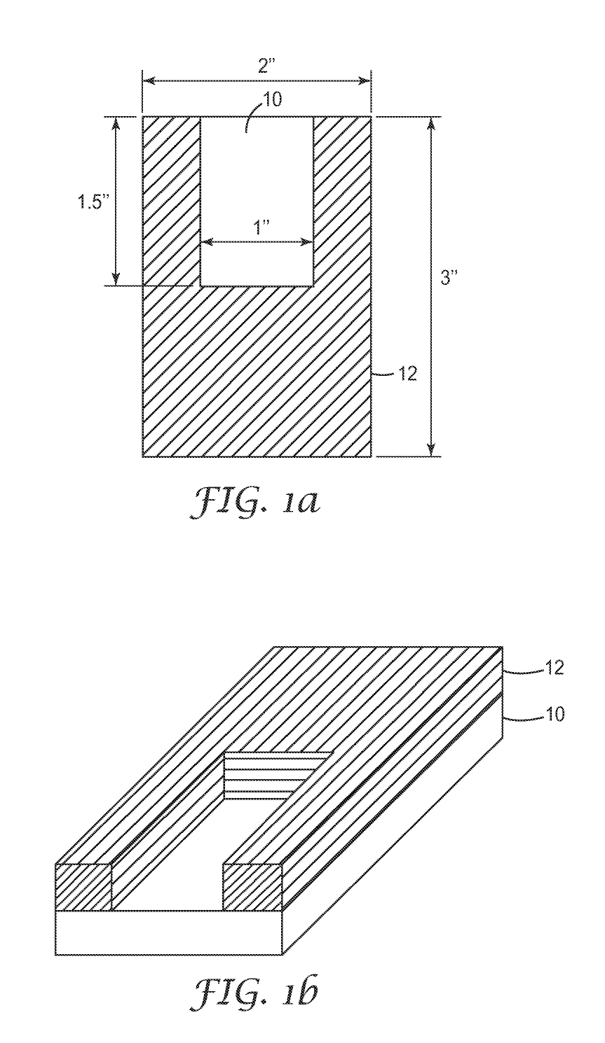

FIGS. 1a and 1b show a top view and a perspective view, respectively, of an example of a substrate 10 having topography. As shown in FIGS. 1a and 1b, in one embodiment, the substrate 10 is a made of glass that is masked on three edges with tape 12. In one embodiment, the tape is 3M®Vinyl Tape 471. Due to the shape of the tape 12 positioned on the substrate 10, the substrate 10 has two different heights. A first height corresponds to the height of the glass substrate and a second height corresponds to the combined heights of the glass substrate and the vinyl tape. The two varying heights create a topography on a surface of the substrate 10, similar to an ink step being printed on a glass or plastic cover lens.

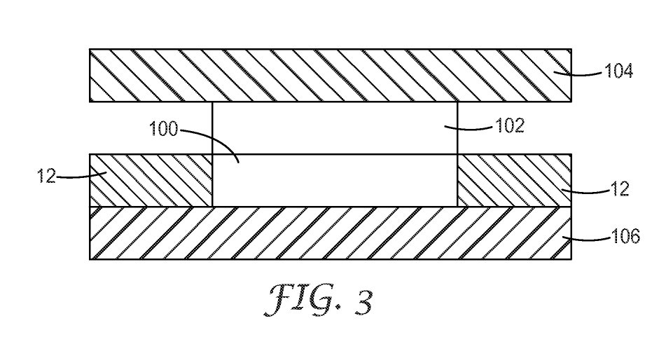

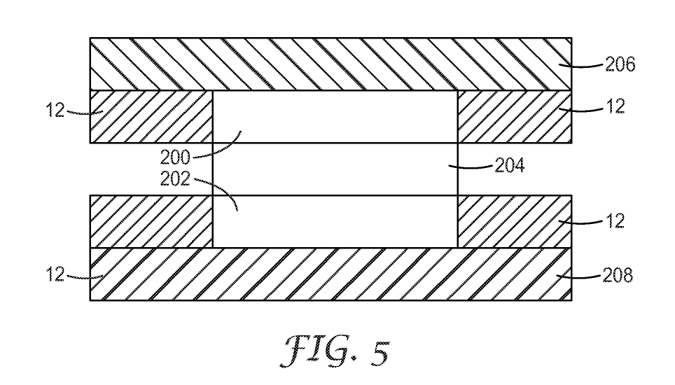

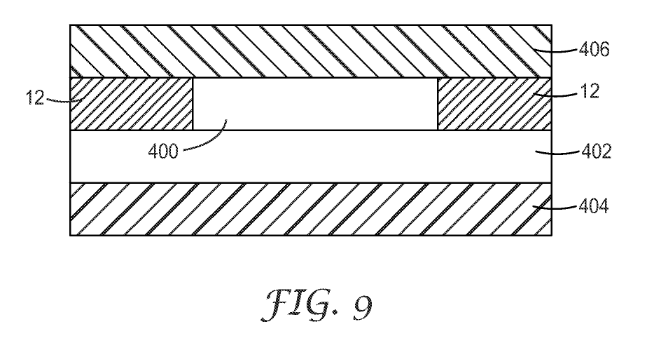

The optical bonding layer can include varying combinations of LOCAs and optical films. In a first embodiment, the optical bonding layer includes a LOCA and an optical film (FIGS. 3 and 9). In a second embodiment, the optical bonding layer includes a first LOCA, a second LOCA and an optical film positioned between the first and second LOCAs (FIGS. 5, 7 and 11).

The LOCA layer facilitates bubble-free lamination of the film adhesive to a substrate without the need for an expensive vacuum laminator and/or autoclave. The LOCA layer can also help fill any height differences which may otherwise lead to delamination or bubble formation in between the substrate and the film adhesive. Because the optical bonding layer also includes an optical film, a lower overall amount of LOCA is needed, minimizing the heat load on a substrate as the LOCA cures.

The LOCA is a liquid optically clear adhesive, an optically diffusive adhesive, a color compensation adhesive or liquid composition that has a viscosity suitable for efficient manufacturing of large optical assemblies. A large optical assembly may have an area of from about 15 cm² to about 5 m² or from about 15 cm² to about 1 m². For example, the liquid composition may have a viscosity of from about 100 to about 10,000 cps, from about 200 to about 1000 cps, from about 200 to about 700 cps, or from about 200 to about 500 cps, wherein viscosity is measured for the composition at 25° C. The liquid composition is amenable for use in a variety of manufacturing methods. Examples of suitable LOCAs include, but are not limited to, high modulus and high adhesion polyurethane adhesives and low modulus and low adhesion urethane acrylate adhesives. An example of a suitable commercially available high modulus and high adhesion polyurethane adhesive includes, but is not limited to, LOCA 2175. An example of a suitable low modulus and low adhesion urethane acrylate adhesive includes, but is not limited to, LOCA 2312. Both are commercially available from 3M Company, St. Paul, Minn.

In general, “curable” is used to describe a composition, layer, region, etc. that cures under predetermined conditions such as application of heat, some type of radiation or energy, or by simply combining two reactive components at room temperature. As used herein, “curable” is used to describe (1) a composition, layer or region that is substantially uncured (i.e. about 50% or less of the reactive monomers have polymerized) and becomes only partially cured or substantially completely cured (i.e. more than 50% of the monomers have polymerized); or (2) a composition, layer or region that is partially cured and partially uncured, and at least some amount of the uncured portion becomes cured; or (3) a composition, layer or region that is substantially uncured and becomes at least partially cured or substantially completely cured.

Any one or combination of curing means may be used to cure the LOCA. For example, UV radiation (200-400 nm), actinic radiation (700 nm or less), near-IR radiation (700-1500 nm), heat and electron beam or any combination thereof may be used. A combination of curing means may be useful, for example, if it is desirable to use actinic radiation to cure the curable layer, except that one or both of the optical substrates has a border that does not allow transmittance of actinic radiation. In this case, heat may be used to cure the curable layer that is not accessible by the actinic radiation because of the border.

The optical film is applied directly onto one of the optical substrates or a LOCA layer. Any suitable optical film or optical film adhesive can be used for the present invention. For example, the optical film can include, but is not limited to: an optically clear film adhesive, a stretch releasable optically clear adhesive and a stretch releasable carrier film. In one embodiment, the optical film is an optically clear adhesive (OCA) film. These OCA films are ready for use for optical assembly and are typically already polymerized. An optional crosslinking or postcuring step may be available to further enhance the cohesiveness of the OCA. In one embodiment, the optical film adhesive is a pressure sensitive adhesive. Pressure sensitive adhesives (PSAs) are well known to possess properties such as: (1) aggressive and even permanent tack, (2) adherence to a substrate with no more than finger pressure, (3) sufficient ability to hold onto an adherent, and/or (4) sufficient cohesive strength to be removed cleanly from the adherend. The optical film or optical film adhesive occupies a significant portion of the air cavity or gap between display substrates to be filled and thus lowers the required volume of liquid adhesive, which reduces the effective shrinkage of the total optical bonding layer, resulting in a reduction in the overall stress in the assembly and reducing the probability of Mura defects. Exemplary suitable film adhesives include, but are not limited to, polyvinyl ethers polyurethanes, silicones, and poly(meth)acrylates (including both acrylates and methacrylates).

The poly(meth)acrylate film adhesive may be prepared from monomers such as alkyl(meth)acrylates. Useful alkyl(meth)acrylates (i.e., acrylic acid alkyl ester monomers) include linear or branched monofunctional acrylates or methacrylates of non-tertiary alkyl alcohols, the alkyl groups having from 1 to 14 and, in particular, from 1 to 12 carbon atoms. Useful monomers include butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, isononyl (meth)acrylate and 2-methyl-butyl (meth)acrylate.

In one embodiment, the optical film is based on at least one poly(meth)acrylate (e.g., is a (meth)acrylic pressure sensitive adhesive). Poly(meth)acrylate adhesives are derived from, for example, at least one alkyl (meth)acrylate ester monomer such as, for example, isooctyl acrylate (IOA), isononyl acrylate, 2-methyl-butyl acrylate, 2-ethyl-hexyl acrylate and n-butyl acrylate, isobutyl acrylate, hexyl acrylate, n-octyl acrylate, n-octyl methacrylate, n-nonyl acrylate, isoamyl acrylate, n-decyl acrylate, isodecyl acrylate, isodecyl methacrylate, and dodecyl acrylate; and at least one optional co-monomer component such as, for example, (meth)acrylic acid, N-vinyl pyrrolidone, N-vinylcaprolactam, N,N-dimethyl(meth)acrylamide, N-isopropyl(meth)acrylamide, (meth)acrylamide, isobornyl acrylate, 4-methyl-2-pentyl acrylate, a hydroxyalkyl (meth)acrylate, a vinyl ester, a polystyrene or polymethyl methacrylate macromer, alkyl maleates and alkyl fumarates (based, respectively, on maleic and fumaric acid), or combinations thereof.

In other embodiments, the poly(meth)acrylic film adhesive can be derived from a composition of between about 0 and about 40 weight percent (wt %) of hydroxyalkyl (meth)acrylate and between about 100 wt % and about 60 wt % of at least one of isooctyl acrylate, 2-ethyl-hexyl acrylate or n-butyl acrylate. The hydroxyethyl(meth)acrylate can be 40%, 30%, 20%, down to 10%, with the balance being an alkylacrylate such as isooctylacrylate, 2-ethylhexylacrylate, butylacrylate, isobornyl acrylate, and the like. In another embodiment, the hydroxyalkyl(meth)acrylate can be replaced with acrylic acid (up to 15% of the total (meth)acrylate composition). One specific embodiment can be derived from a composition of between about 1 wt % and about 2 wt % hydroxyalkyl(meth)acrylate and between about 99 wt % and about 98 wt % of at least one of isooctyl acrylate, 2-ethylhexyl acrylate or n-butyl acrylate. Another specific embodiment can be derived from a composition of about 1 wt % to about 2 wt % hydroxyalkyl (meth)acrylate, and about 99 wt % to about 98 wt % of a combination of n-butyl acrylate and methyl acrylate.

Various functional materials can also be added, including, but not limited to: oils, plasticizers, antioxidants, UV stabilizers, pigments, curing agents, polymer additives, thickening agents, dyes, chain transfer agents and other additives, provided that they do not significantly reduce the optical clarity of the film adhesive.

Optionally, the optical film may include a stretch releasable optically clear adhesive (SROCA) and/or a carrier film having stretch release properties, i.e. a stretch releasable carrier film (SRCF). The stretchable layer can be inserted between a layer of LOCA and a substrate, or between layers of LOCA. The addition of the SROCA or SRCF facilitates rework of the assembly, allowing for easy assembly and disassembly of displays. Examples of suitable SROCAs have been described in U.S. Patent Application Publication Nos. 2009/0229732 A1, 2011/0126968 A1 and 2011/0253301 A1.

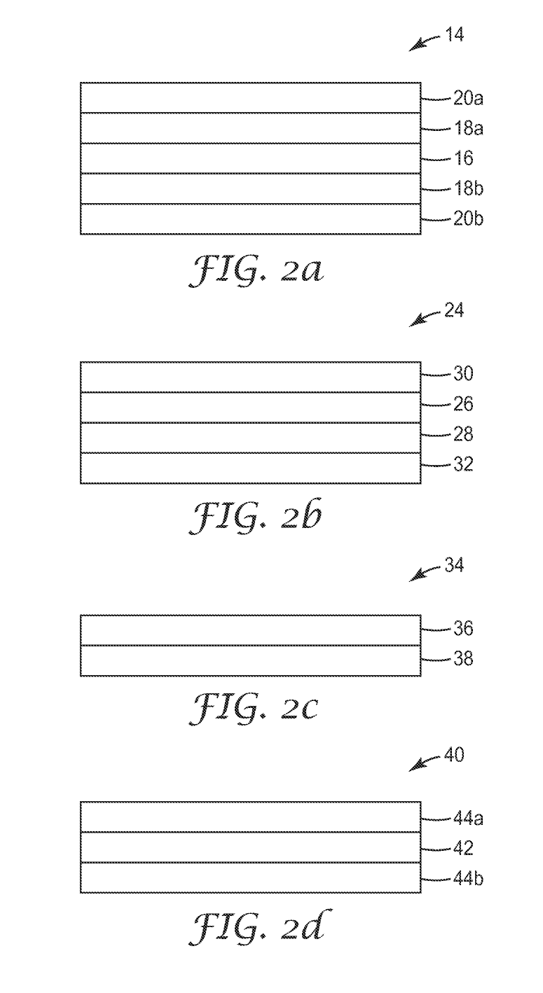

FIGS. 2a-2d provide examples of various constructions of the optical bonding layer of the present invention. FIG. 2a shows a cross-sectional view of a full construction of an optical film 14 which includes a carrier film 16 positioned between a first OCA 18a and a second OCA 18b. A full construction includes two layers of OCA with a stretch releaseable carrier film 16 in between. Release liners 22a and 22b are positioned on the surfaces of the OCAs 18a, 18b, respectively, to maintain cleanliness until ready for use.

FIG. 2b shows a cross-sectional view of a half construction of an optical film 24 which includes an OCA 26 and a carrier film 28. A release liner 30 is positioned adjacent to the OCA 26 to maintain cleanliness until ready for use. A premask liner 32 is positioned adjacent to the carrier film 28, also to keep the surface from becoming contaminated with particles, fibers, and the like.

In yet another embodiment shown in FIG. 2c, an optical film 34 of the optical bonding layer includes only a stretch releasable carrier film (SRCF) 36. A premask liner 38 is positioned adjacent the carrier film 36.

FIG. 2d shows a cross-sectional view of an optical film 40 that includes only an OCA 42 positioned between release liners 44a and 44b.

The optical bonding layer of the present invention is useful for the application of transparent overlayers to a wide variety of display panels, for example, liquid crystal display panels, OLED display panels, and plasma display panels.

In some embodiments, the optical assembly includes a liquid crystal display assembly wherein the display panel includes a liquid crystal display panel. Liquid crystal display panels are well known and typically include a liquid crystal material disposed between two substantially transparent substrates such as glass or polymer substrates. As used herein, substantially transparent refers to a substrate that has, per millimeter thickness, a transmission of greater than about 85% at 400 nm, greater than about 90% at 530 nm and greater than about 90% at 670 nm. On the inner surfaces of the substantially transparent substrates are transparent electrically conductive materials that function as electrodes. In some cases, on the outer surfaces of the substantially transparent substrates are polarizing films that pass essentially only one polarization state of light. When a voltage is applied selectively across the electrodes, the liquid crystal material reorients to modify the polarization state of light, such that an image is created. The liquid crystal display panel may also include a liquid crystal material disposed between a thin film transistor (TFT) array panel having a plurality of TFTs arranged in a matrix pattern and a common electrode panel having a common electrode.

In some embodiments, the optical assembly includes a plasma display assembly wherein the display panel includes a plasma display panel. Plasma display panels are well known and typically include an inert mixture of noble gases such as neon and xenon disposed in many tiny cells located between the two glass panels. Control circuitry charges electrodes within the panel cause the gases to ionize and form a plasma which then excites phosphors to emit light.

In some embodiments, the optical assembly includes an organic electroluminescent assembly wherein the display panel includes an organic light emitting diode or light emitting polymer disposed between two glass panels.

Other types of display panels can also benefit from display bonding, for example, electrophoretic displays having touch panels such as those used in electronic paper displays.

The optical assembly also includes a substantially transparent substrate that has, per millimeter thickness, a transmission of greater than about 85% at 400 nm, greater than about 90% at 530 nm and greater than about 90% at 670 nm. In a typical liquid crystal display assembly, the substantially transparent substrate may be referred to as a front or rear cover plate. The substantially transparent substrate may include glass or polymer. Useful glasses include borosilicate, sodalime, and other glasses suitable for use in display applications as protective covers. Useful polymers include, but are not limited to polyester films such as PET, polycarbonate films or plates, acrylic plates and cycloolefin polymers, such as Zeonox and Zeonor available from Zeon Chemicals L.P. The substantially transparent substrate particularly has an index of refraction close to that of the display panel and/or the photopolymerizable layer. For example, between about 1.45 and about 1.55. The substantially transparent substrate typically has a thickness of from about 0.5 to about 5 mm.

In some embodiments, the substantially transparent substrate includes a touch screen. Touch screens are well known in the art and generally include a transparent conductive layer disposed between two substantially transparent substrates. For example, a touch screen may include indium tin oxide disposed between a glass substrate and a polymer substrate.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following example are on a weight basis.

### Materials

| Identification | Description |
|---|---|
| CN9018 | Urethane diacrylate oligomer available under the trade designation CN9018 from |
| | Sartomer, USA, LLC, Exton, Pennsylvania |
| CD611 | Alkoxylated tetrahydrofurfuryl acrylate available under the trade designation CD611 |
| | from Sartomer, USA, LLC |
| SR506A | Isobornyl acrylate available under the trade designation SR506A from Sartomer, |
| | USA, LLC |
| Bisomer PPA6 | Polypropyleneglycol monoacrylate available under the trade designation BISOMER |
| | PPA6 from Cognis Ltd., Southampton, UK |
| Soybean oil | Soybean oil available from Sigma-Aldrich Chemical Company, St. Louis, Missouri |
| TPO-L | Ethyl-2,4,6-trimethylbenzoylphenylphosphinate available under the trade |
| | designation LUCIRIN TPO-L from BASF Corporation, Florham Park, New Jersey |
| Irgacure 184 | 1-Hydroxycyclohexyl phenyl ketone available under the trade designation |
| | IRGACURE 184 from BASF, Tarrytown, New York |
| LOCA1 | A liquid optically clear adhesive, available under the trade designation 3M ™ Liquid |
| | Optically Clear Adhesive 2175, from the 3M Company, St. Paul, Minnesota |
| DytekA | 2-methylpentamethylenediamine available under the trade designation DYTEK A |
| | from Invista S. ar. I., Wilmington, Delaware |
| PDSDA | α,ω-bis(aminopropyl) polydimethylsiloxane diamines, made 3M internally following |
| | the procedure outlined in U.S. Pat. No. 5,461,134 (Leir, et al.) |
| H12MDI | 4,4′-methylene-dicyclohexyldiisocyanate available under the trade designation |
| | Desmodur W from Bayer MaterialScience LLC, Pittsburg, Pennsylvania |
| LOCA2 | A liquid optically clear adhesive mixture of 39.6% CN9018, 21.2% CD611, 17.0% |
| | SR506A, 12.7% Bisomer PPA6, 8.5% Soybean oil, 0.50% TPO-L and 0.50% |
| | Irgacure 184 (based on weight) |
| OCA1 | A 5 mil (125 micron) acrylic based adhesive, available under the trade designation |
| | 3M ™ Optically Clear Adhesive 8185, from the 3M Company |
| OCA2 | A 5 mil (125 micron) acrylic based adhesive, available under the trade designation |
| | 3M ™ Optically Clear Adhesive 8165, from the 3M Company |
| SROCA1 | A stretch releasable optically clear adhesive prepared internally, as described below |
| SROCA2 | A stretch releasable optically clear adhesive prepared internally, as described below |
| SRCF1 | A stretch releasable carrier film prepared internally, as described below |

### Test Methods

### Haze and Transmission

The haze (%) and transmission (%) were measured using a Hunter Ultrascan PRO, model USP 1469 available from HunterLab, Reston, Va.

### Stretch Release Force (SRF)

Testing was conducted using a tensile tester, model number 5500 available from Instron Corporation, Canton, Mass. A 500 Newton load cell, available from Instron Corporation, was used. Testing was conducted at an extension rate of 12 in/min (30.5 cm/min). The bottom jaw of the tensile testing machine held the edge of the optical assembly opposite the stretch release material tab. The top jaw of the testing machine held the stretch release tab of the optical assembly.

### Preparation of Adhesives

### Preparation of SROCA1

A SPU elastomer (silicone polyurea block copolymer) was made by mixing (1) PDSDA having a weight average molecular weight of about 35,000 grams/mole, (2) DytekA, and (3) H12MDI in a weight ratio of 1/1/2 with a toluene/isopropanol mixture (70/30 by weight) and allowing the polymer to fully chain-extend. The final solid content of this elastomer mixture was 20 weight percent.

The elastomer was further compounded with a 60 weight percent solution of MQ tackifier resin available under the trade designation DC Q2-7066 (from Dow Corning, Midland, Mich.) to prepare a 30 weight percent solids mixture of the SPU elastomer/MQ tackifier resin. The weight ratio of the SPU elastomer to MQ resin was 50/50 on a solids basis. After thorough mixing, the adhesive composition was coated on a fluorosilicone release liner and oven dried in a 70° C. oven for 15 minutes to yield a dry coating of the SPU pressure-sensitive adhesive The dry adhesive thickness was about 37.5 micrometers. Two SPU coatings were prepared in this manner. The release liner used for one of the SPU coatings was MDO7 and MD11 was used for the other SPU coating. By using two different release liners, it was possible to maintain a differentiated release level in the construction of SROCA1, facilitating liner removal prior to the assembly process. MDO7 and MD11 release liners were obtained from Siliconature S.p.A., Italy.

In a second step, the dried SPU adhesive coating was laminated against both sides of a piece of SRCF1. Preparation of SRCF1 is described below.

### Preparation of SROCA2

This sample was made similarly to SROCA1, except that only one layer of SPU adhesive was laminated against one side of a piece of SRCF1. Since no liner release differential is needed, either the MD07 or the MD11 release liner can be used.

### Preparation of SRCF1

Stretch releasable carrier film (SRCF1) was a 100 micron thick co-extruded film of an ethylene based octene plastomer available under the trade designation EXACT 8203 (from Exxon Mobile Corporation, Irving, Tex.) and a copolymer of ethylene and methyl acrylate available under the trade designation ELVALOY AC 1609 (from EI DuPont de Nemours & Co, Wilmington, Del.). The ELVALOY AC 1609 forms the outer skin of the coextruded film with a thickness of about 10 microns, while the center layer is made from the EXACT 8203 resin with a thickness of about 80 microns.

### Examples 1-4

The optical assemblies of Examples 1-4 included at least one LOCA and one stretch release optically clear adhesive (SROCA).

FIG. 3 shows a cross-sectional view of the optical assemblies of Examples 1-4. The optical bonding layers of Examples 1-4 include a LOCA 100 and a SROCA 102. The LOCA 100 is positioned on a surface of the second substrate 106 and the SROCA 102 is positioned between the LOCA 100 and the first substrate 104.

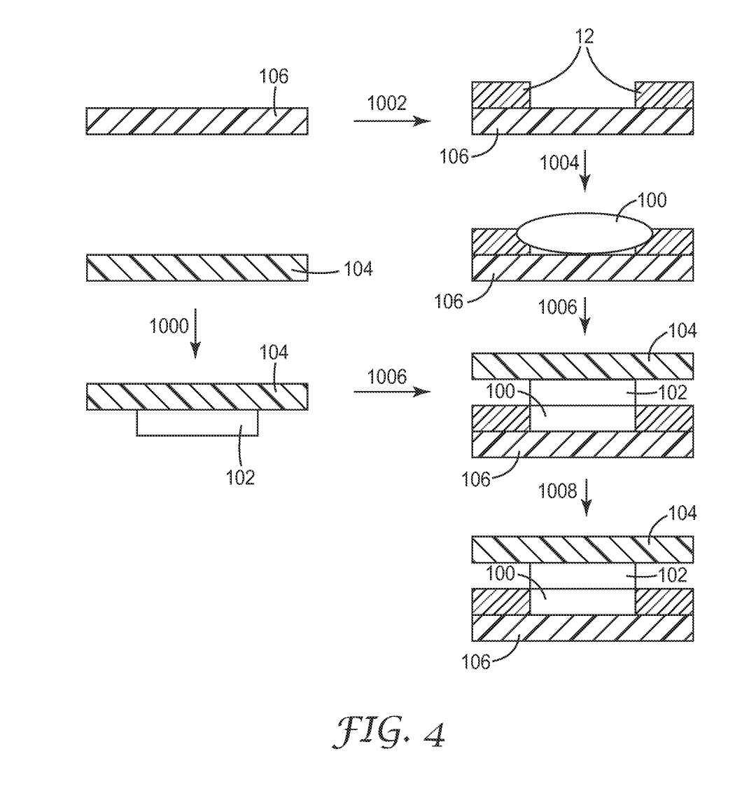

FIG. 4 shows a schematic cross-sectional view of a method of lamination of Examples 1-4. In an assembly where only one layer of LOCA is used, a first substrate 104 is laminated with a film adhesive, such as a SROCA 102, positioned on the first substrate 104 (step 1000).

After tape 12 is applied onto three edges of a second substrate 106 to contain the LOCA 100 (step 1002), the LOCA 100 is dispensed onto the second substrate 106 (step 1004). Next, the first substrate 104 and SROCA 102 is laminated to the LOCA 100 (step 1006). Because the LOCA 100 is a liquid, the LOCA 100 is able to fill in the topography of the second substrate 106. The optical bonding layer formed from the combination of the SROCA 102 and the LOCA 100 is then UV cured through the first substrate 104 (step 1008).

### Example 1

An optical assembly was prepared as follows. A sheet of SROCA1 was cut to 2.0 inches (5.1 cm)×1 inch (2.5 cm) and a MDO7 release liner was removed exposing the pressure sensitive OCA. The SROCA1 was then laminated to a 3 inch (7.6 cm)×2 inch (5.1 cm)×1 mm first glass substrate via the exposed pressure sensitive adhesive using a hand roller. A half inch long tab of the SROCA1 extended from the edge of the glass substrate to allow for stretch release force testing. Care was taken to insure that there were no trapped air bubbles. A second substrate, a 3 inch (7.6 cm)×2 inch (5.1 cm)×1 mm rectangular glass plate, was masked on three edges, both lengths and one width, using 3M™ Vinyl Tape 471 available from 3M Company. The 5.1 mil (0.13 mm) thick tape created a 1.5 inch (3.8 cm)×1 inch (2.5 cm) gap of similar thickness of the tape. An appropriate amount of LOCA1, at least enough to fill the gap completely, was dispensed with a pipette onto the glass of the gap region of the second substrate. After removing the second liner from SROCA1 and exposing the second pressure sensitive adhesive of SROCA1, the first substrate and the second substrate were then laminated together such that the second pressure sensitive adhesive of stretch release adhesive, SROCA1, contacted the liquid optically clear adhesive, LOCA1, of the second substrate. The area of the gap was matched to the 1.5 inch (3.8 cm)×1 inch (2.5 cm) area of SROCA1. After lamination of the first and second substrates, LOCA1 was cured by exposing the optical assembly to ultra violet radiation, UVA, at a dosage of 3 J/cm² using a low intensity UVA black lamp (a 350 nm peak emission Blacklight, 40 W, F40/BL available from Sylvania, Danvers, Mass.) with UVA intensity of 2.8 mW/cm². Haze, transmission and stretch release force measurements were made per the above test methods.

### Example 2

Example 2 was prepared similarly to Example 1 except that LOCA1 was replaced by LOCA2.

### Example 3

Example 3 was prepared similarly to Example 1 except that the sheet of SROCA1 was replaced by a sheet of SROCA2. As SROCA2 has only one pressure sensitive adhesive layer, the liner was removed exposing the pressure sensitive OCA and SROCA2 was laminated to the first glass substrate. After removing the premask from the carrier film of SROCA2, the two glass substrates were then laminated together by contacting the liquid optically clear adhesive, LOCA1, of the second glass substrate with the exposed carrier film of SROCA2 of the first glass substrate.

### Example 4

Example 4 was prepared similarly to Example 3 except LOCA1 was replaced by LOCA2.

### Examples 5-8

The optical assemblies of Examples 5-8 included at least one LOCA and one stretch release optically clear adhesive (SROCA).

FIG. 5 shows a cross-sectional view of the optical assemblies of Examples 5-8. The optical bonding layers of Examples 5-8 include a first LOCA 200, a second LOCA 202 and a film adhesive 204. The first LOCA 200 is positioned on a surface of the first substrate 206 and the second LOCA 202 is positioned on a surface of the second substrate 208. The film adhesive 204, a SROCA, is positioned between the first and second LOCAs 200 and 202.

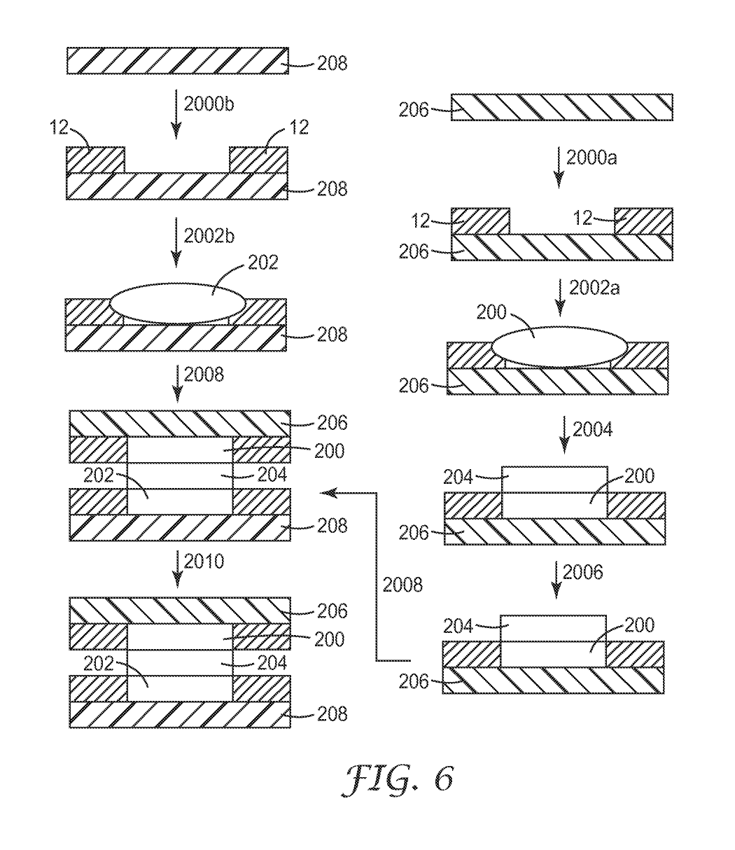

FIG. 6 shows a schematic cross-sectional view of a method of lamination of Examples 5-8. In an assembly where two layers of LOCA are used, after tape 12 is applied onto three edges of each of the first and second substrates 206 and 208 (steps 2000a and 2000b), respectively, the first LOCA 200 is dispensed onto the first substrate 206 (step 2002a), and the second LOCA 202 is dispensed onto the second substrate 208 (step 2002b). Next, the film adhesive 204 is positioned on the first LOCA 200 (step 2004) and the first LOCA 200 and the film adhesive 204 are UV cured through the first substrate 206 (step 2006). The second LOCA 202 is then placed in contact with the film adhesive 204 (step 2008) and the second LOCA 202 and film adhesive 204 are UV cured (step 2010), forming the optical assembly. If desired, the two layers of LOCA 200 and 202 may be cured at the same time.

### Example 5

A first glass substrate and a second glass substrate, as described in Example 1, were both masked with tape, as described in Example 1. An appropriate amount of LOCA1, at least enough to fill the gap completely, was dispensed with a pipette onto the glass of the gap region of the first substrate. A sheet of SROCA1 was cut to 2.0 (3.1 cm) inches×1 inch (2.5 cm) and the MDO7 release liner was removed exposing the pressure sensitive OCA. The exposed pressure sensitive OCA of SROCA1 was then placed directly onto LOCA1 of the first glass substrate. A half inch long tab of the SROCA1 extended from the edge of the glass substrate, to allow for stretch release force measurements. Care was taken to insure that there were no trapped air bubbles. LOCA1 was cured as described in Example 1. An appropriate amount of LOCA1, at least enough to fill the gap completely, was dispensed with a pipette onto the glass of the gap region of second substrate. The second liner of SROCA1 was removed from the first substrate with cured LOCA1, exposing the pressure sensitive OCA. The exposed pressure sensitive adhesive was then placed in contact with LOCA1 of the second substrate. LOCA1 of the second substrate was cured as described in Example 1.

### Example 6

Example 6 was prepared similarly to Example 5 except that LOCA1 was replaced by LOCA2 for both substrates.

### Example 7

Example 7 was prepared similarly to Example 5 except that the sheet of SROCA1 was replaced by a sheet of SROCA2. As SROCA2 has only one pressure sensitive adhesive layer, the liner was removed exposing the pressure sensitive OCA and the pressure sensitive adhesive was then placed directly onto LOCA1 of the first glass substrate. After removing the premask from the carrier film of SROCA2, the two glass substrates were then laminated together by contacting the liquid optically clear adhesive, LOCA1, of the second glass substrate with the carrier film of SROCA2 of the first glass substrate.

### Example 8

Example 8 was prepared similarly to Example 7 except that LOCA1 was replaced by LOCA2.

Table 1 below provides a summary of the type of LOCA, the number of LOCA layers and the type of SROCA used in Examples 1-8.

TABLE 1
Adhesives Layers for Examples 1-8

| Example | LOCA Type | # LOCA Layers | SROCA Type |
|---|---|---|---|
| 1 | LOCA1 | 1 | SROCA1 |
| 2 | LOCA2 | 1 | SROCA1 |
| 3 | LOCA1 | 1 | SROCA2 |
| 4 | LOCA2 | 1 | SROCA2 |
| 5 | LOCA1 | 2 | SROCA1 |
| 6 | LOCA2 | 2 | SROCA1 |
| 7 | LOCA1 | 2 | SROCA2 |
| 8 | LOCA2 | 2 | SROCA2 |

Test results at particular aging times, temperatures and humidity conditions are shown in Table 2.

TABLE 2
Test Results for Examples 1-8

| | 30 days aging @ | | | 30 days aging @ | | | | | |
|---|---|---|---|---|---|---|---|---|---|
| | 23° C. and 50% | | | 65° C. and 90% | | | 30 days | | |
| | relative humidity | | | relative humidity | | | aging @ 70° C. | | |
| | | | SRF | | | SRF | | | SRF |
| Ex. | % Haze | % Trans | (lb/in) | % Haze | % Trans | (lb/in) | % Haze | % Trans | (lb/in) |
| 1 | 4.4 | 88.70 | 6.11 | 5.3 | 82.98 | 5.81 | 5.8 | 82.74 | 9.94 |
| 2 | 3.4 | 90.80 | 4.95 | 11.6 | 90.21 | 4.08 | 1.0 | 90.95 | 4.75 |
| 3 | 1.9 | 91.08 | 4.34 | 0.7 | 91.22 | broke | 1.5 | 91.19 | broke |
| 4 | 2.8 | 91.01 | 4.40 | 8.1 | 90.59 | 3.31 | 1.2 | 91.10 | broke |
| 5 | 5.4 | 90.09 | — | 4.3 | 90.57 | — | 5.7 | 90.44 | — |
| 6 | 1.6 | 87.78 | — | 3.4 | 83.93 | — | 3.4 | 84.09 | — |
| 7 | 6.9 | 90.42 | — | 5.2 | 90.44 | — | 5.5 | 90.25 | — |
| 8 | 1.1 | 90.00 | — | 0.9 | 88.75 | — | 0.6 | 89.71 | — |

The results in Table 2 illustrate that using a combination of a LOCA and a SROCA allows substrates, even with uneven surfaces, to be bonded without any bubbles. In addition, in some cases the combination of a SROCA with a LOCA successfully separated the bonded parts before and after aging. In all cases, defect free optical assemblies (i.e. no air bubbles trapped between substrates) were obtained with good durability upon aging.

### Examples 9-12

The optical assemblies of Examples 9-12 included at least two LOCAs and at least one optically clear adhesive (OCA).

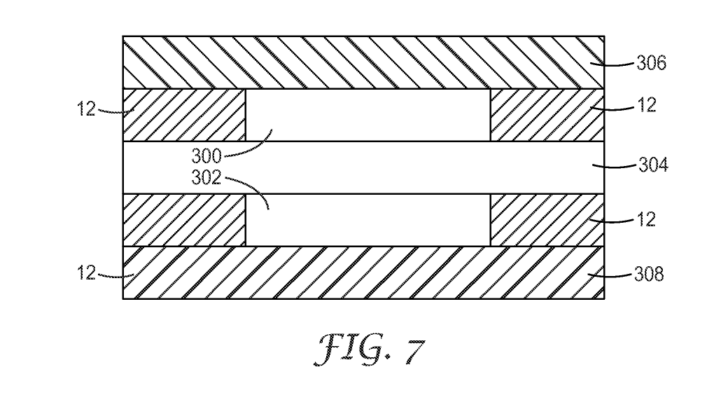

FIG. 7 shows a cross-sectional view of the optical assemblies of Examples 9-12. The optical bonding layers of Examples 9-12 include a first LOCA 300, a second LOCA 302 and an OCA 304. The first LOCA 300 is positioned on a surface of the first substrate 306 and the second LOCA 302 is positioned on a surface of the second substrate 308. The OCA 304 is positioned between the first and second LOCAs 300 and 302.

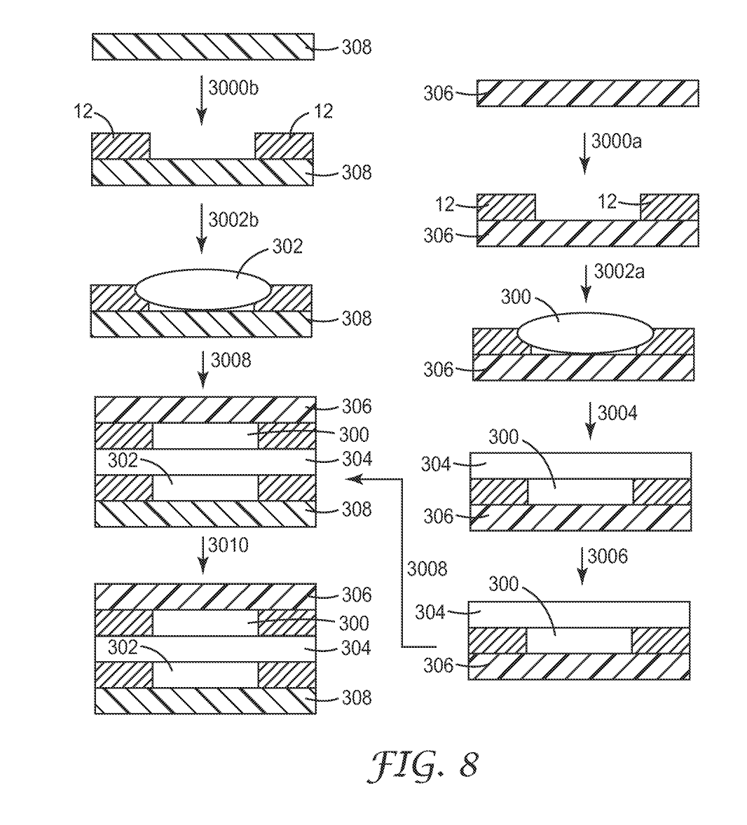

FIG. 8 shows a schematic cross-sectional view of a method of lamination of Examples 9-12. In an assembly where two layers of LOCA are used, after tape 12 is applied onto three edges of each of the first and second substrates 306 and 308 (steps 3000a and 3000b), respectively, the first LOCA 300 is dispensed onto the first substrate 306 (step 3002a) and the second LOCA 302 is dispensed onto the second substrate 308 (step 3002b). Next, the OCA 304 is positioned on the first LOCA 300 (step 3004) and the first LOCA 300 is UV cured through the first substrate 306 and OCA 304 (step 3006). The second LOCA 302 is then placed in contact with the OCA 304 (step 3008) and the second LOCA 302 and OCA 304 are UV cured (step 3010), forming the optical assembly. If desired, the two layers of LOCA 300 and 302 may be cured at the same time.

### Example 9

Example 9 was prepared similarly to Example 5 except SROCA1 was replaced by OCA1. The dimensions of the OCA1 were 1.5 inches (3.8 cm)×1.0 inch (2.5 cm). A tab was not required in this instance. The liner with lower removal force was removed and the OCA was placed onto the LOCA1 of substrate 1. Curing was conducted as described in Example 1. The second liner was removed from OCA1 and the exposed pressure sensitive adhesive was brought into contact with LOCA1 of the second substrate and similarly cured.

### Example 10

Example 10 was prepared similarly to Example 9 except OCA1 was replaced by OCA2.

### Example 11

Example 11 was prepared similarly to Example 9 except LOCA1 was replaced by LOCA2.

### Example 12

Example 12 was prepared similarly to Example 10 except LOCA1 was replaced by LOCA2.

### Examples 13-16

The optical assemblies of Examples 13-16 included at least one LOCA and at least one optically clear adhesive (OCA).

FIG. 9 shows a cross-sectional view of the optical assemblies of Examples 13-16. The optical bonding layers of Examples 13-16 include a LOCA 400 and an OCA 402. The OCA 402 is positioned on a surface of the first substrate 404, and the LOCA 400 is positioned between the OCA 402 and the second substrate 406.

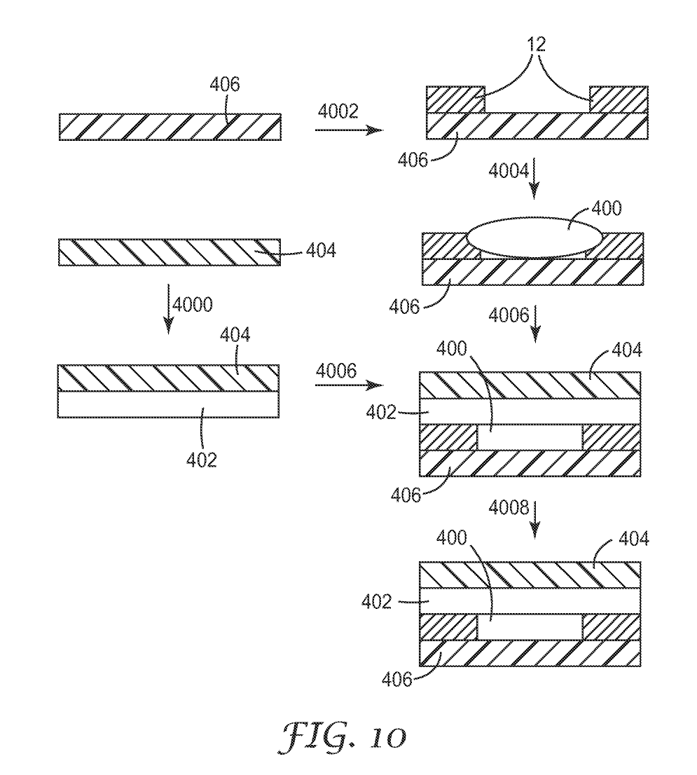

FIG. 10 shows a schematic cross-sectional view of a method of lamination of Examples 13-16. In an assembly where only one layer of LOCA is used, a first substrate 404 is laminated with the OCA 402 positioned on the first substrate 404.

After tape 12 is then applied onto three edges of the second substrate 406 to contain the LOCA (step 4002), the LOCA 400 is dispensed onto the second substrate 406 (step 4004). Next, the first substrate 404 is laminated to the LOCA 400 (step 4006). Because the LOCA 400 is a liquid, the LOCA 400 is able to fill in the topography of the second substrate 406. The optical bonding layer formed from the combination of the OCA 402 and the LOCA 400 are then UV cured through the second substrate 406 (step 4008). The OCA 402 is typically already cured and no longer reactive to UV, except if a second UV exposure causes the OCA 402 to crosslink more.

### Example 13

Example 13 was prepared similarly to Example 1 except SROCA1 was replaced by OCA1. The dimensions of the OCA1 were 1.5 inches (3.8 cm)×1.0 inch (2.5 cm). A tab was not required in this instance. The liner with lower removal force was removed and OCA1 was laminated to the glass of Substrate 1 using a hand roller. The second liner was removed from OCA1 and the exposed pressure sensitive adhesive was brought into contact with LOCA1 of Substrate 2. Curing was conducted as described in Example 1.

### Example 14

Example 14 was prepared similarly to Example 13 except OCA1 was replaced by OCA2.

### Example 15

Example 15 was prepared similarly to Example 13 except LOCA1 was replaced by LOCA2.

### Example 16

Example 16 was prepared similarly to Example 14 except LOCA1 was replaced by LOCA2.

### Examples 17 and 18

The optical assemblies of Examples 17 and 18 included at least two LOCAs and at least one optically clear adhesive (OCA).

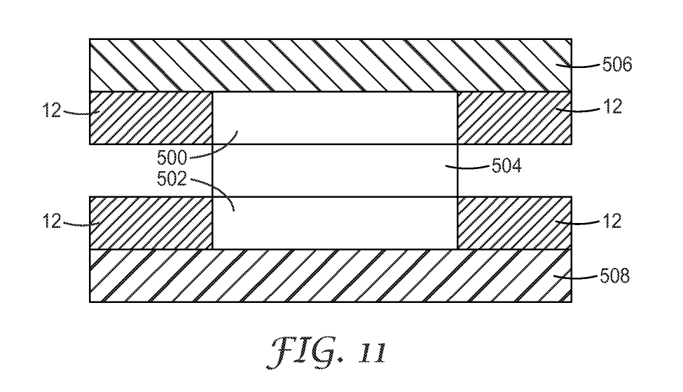

FIG. 11 shows a cross-sectional view of the optical assemblies of Examples 17 and 18. The optical bonding layers of Examples 17 and 18 include a first LOCA 500, a second LOCA 502 and a stretch release carrier film (SRCF) 504. The first LOCA 500 is positioned on a surface of the first substrate 506 and the second LOCA 502 is positioned on a surface of the second substrate 508. The SRCF 504 is positioned between the first and second LOCAs 500, 502.

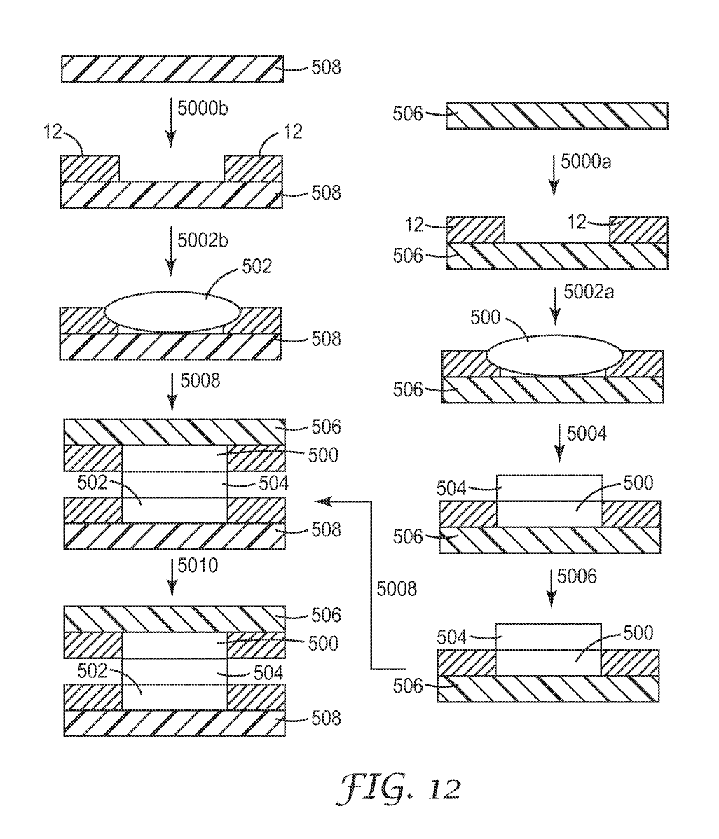

FIG. 12 shows a schematic cross-sectional view of a method of lamination of Examples 17 and 18. In an assembly where two layers of LOCA are used, after tape 12 is applied onto three edges of each of the first and second substrates 506 and 508 (steps 5000a and 5000b), respectively, the first LOCA 500 is dispensed onto the first substrate 506 (step 5002a) and the second LOCA 502 is dispensed onto the second substrate 508 (step 5002b). Next, the SRCF 504 is positioned on the first LOCA 500 (5004) and the first LOCA 500 is UV cured through the first substrate 506 and SRCF 504 (step 5006). The second LOCA 502 is then placed in contact with the SRCF 504 (step 5008) and the second LOCA 502 is UV cured (step 5010), forming the optical assembly. If desired, the two layers of LOCA 500 and 502 may be cured at the same time.

### Example 17

Example 17 was prepared similarly to Example 13, except that the SROCA1 was replaced by a SRCF1.

### Example 18

Example 18 was prepared similarly to Example 17, except that the LOCA1 was replaced by LOCA2.

Table 3 below provides a summary of the type of LOCA, the number of LOCA layers and the type of OCA used in Examples 9-18.

TABLE 3
Adhesives Layers for Examples 9-18

| | | | OCA or Film |
|---|---|---|---|
| Example | LOCA Type | # LOCA Layers | Type |
| 9 | LOCA1 | 2 | OCA1 |
| 10 | LOCA1 | 2 | OCA2 |
| 11 | LOCA2 | 2 | OCA1 |
| 12 | LOCA2 | 2 | OCA2 |
| 13 | LOCA1 | 1 | OCA1 |
| 14 | LOCA1 | 1 | OCA2 |
| 15 | LOCA2 | 1 | OCA1 |
| 16 | LOCA2 | 1 | OCA2 |
| 17 | LOCA1 | 2 | SRCF1 |
| 18 | LOCA2 | 2 | SRCF1 |

Test results at particular aging times, temperatures and humidity conditions are shown in Table 4.

TABLE 4
Test Results for Examples 9-18

| | 30 days aging @ | | 30 days aging @ | | | |
|---|---|---|---|---|---|---|
| | 23° C. and | | 65° C. and | | | |
| | 50% relative | | 90% relative | | 30 days | |
| | humidity | | humidity | | aging @ 70° C. | |
| Example | % Haze | % Trans | % Haze | % Trans | % Haze | % Trans |
| 9 | 2.0 | 90.81 | 0.2 | 91.05 | 0.1 | 90.92 |
| 10 | 0.9 | 90.61 | 0.3 | 91.09 | 1.1 | 90.69 |
| 11 | 4.9 | 90.89 | 7.6 | 89.92 | 0.8 | 91.19 |
| 12 | 7.2 | 90.69 | 1.6 | 90.91 | 3.2 | 91.13 |
| 13 | 2.7 | 90.97 | 0.1 | 91.47 | 0.1 | 91.33 |
| 14 | 2.3 | 90.95 | 1.9 | 92.06 | 0.4 | 91.23 |
| 15 | 3.1 | 90.99 | 0.2 | 91.77 | 0.1 | 91.50 |
| 16 | 3.5 | 91.16 | 0.4 | 91.69 | 0.2 | 91.45 |
| 17 | 3.7 | 90.37 | 5.5 | 90.88 | 6 | 90.36 |
| 18 | 0.8 | 90.88 | 0.5 | 90.90 | 0.6 | 90.67 |

The results in Table 4 illustrate that using a combination of LOCA and an OCA allows substrates, even with uneven surfaces, to be bonded without any bubbles.

Although the present invention has been described with reference to preferred embodiments, workers skilled in the art will recognize that changes may be made in form and detail without departing from the spirit and scope of the invention

What is claimed is:

1. An optical bonding layer comprising:
an optical film; and
a first liquid optically clear adhesive (LOCA) positioned adjacent the first optical film;
wherein the optical bonding layer has a transmittance of at least about 75%.

2. The optical bonding layer of claim 1, wherein the optical film is one of an optically clear film adhesive, a stretch releasable optically clear adhesive and a stretch releasable carrier film.

3. The optical bonding layer of claim 1, wherein the optical film has at least one of the following properties: diffusivity, color compensation, UV absorption and IR absorption.

4. The optical bonding layer of claim 1, wherein the optical film comprises a first stretch releasable optically clear adhesive and a stretch releasable carrier film.

5. The optical bonding layer of claim 4, wherein the optical film further comprises a second stretch releasable optically clear adhesive, wherein the stretch releasable carrier film is positioned between the first and the second stretch releasable optically clear adhesives.

6. The optical bonding layer of claim 1, further comprising a second LOCA positioned adjacent the optical film.

7. A display assembly comprising:
a first substrate;
a second substrate; and
an optical bonding layer positioned between the first substrate and the second substrate, the optical bonding layer comprising:
an optical film; and
a first liquid optically clear adhesive (LOCA) positioned adjacent the optical film.

8. The display assembly of claim 7, wherein the optical bonding layer further comprises a second LOCA, wherein the optical film is positioned between the first and the second LOCAs.

9. The display assembly of claim 7, wherein the optical film is one of an optically clear film adhesive, a stretch releasable optically clear adhesive and a stretch releasable carrier film.

10. The display assembly of claim 7, wherein the optical film has at least one of the following properties: diffusivity, color compensation, UV absorption and IR absorption.

11. The display assembly of claim 7, wherein the optical film comprises a first stretch releasable optically clear adhesive and a stretch releaseable carrier film.

12. The display assembly of claim 11, wherein the optical film further comprises a second stretch releasable optically clear adhesive and wherein the stretch releaseable carrier film is positioned between the first and second stretch releasable optically clear adhesives.

13. The display assembly of claim 7, wherein the display assembly has no visible bond lines.

14. The display assembly of claim 7, wherein the display assembly has a transmittance of at least about 75%.

15. A method of making a display assembly, the method comprising:
positioning an optical film onto a first substrate;
laminating the first substrate with the optical film;
dispensing a first liquid optically clear adhesive (LOCA) onto a second substrate;
contacting the optical film and the first LOCA, wherein the optical film and the first LOCA form an optically clear bonding layer;
laminating the second substrate to the first LOCA; and
curing the optical bonding layer.

16. The method of claim 15, wherein curing the bonding layer comprises curing by ultraviolet light radiation.

17. The method of claim 15, wherein at least the first substrate includes topography.

18. The method of claim 15, further comprising dispensing a second LOCA onto the first substrate prior to positioning the optical film onto the first substrate.

19. The method of claim 15, wherein the optical film is one of an optically clear film adhesive, a stretch releasable optically clear adhesive and a stretch releasable carrier film.

20. The method of claim 15, wherein the optical film is a stretch releasable carrier film and wherein the first LOCA is dispensed between the stretch releasable carrier film and the first substrate.
